(19) United States
(12) Patent Application Publication
(10) Pub. No.: US 2008/0268215 A1
(43) Pub. Date: Oct. 30, 2008

(54) Thin-Film Laminate

(75) Inventors: Yoshiko Hattori, Tokyo-To (JP); Koichi Mikami, Tokyo-To (JP); Yukimitsu Iwata, Tokyo-To (JP); Hidetake Miyazaki, Tokyo-To (JP)

Correspondence Address: BURR & BROWN, PO BOX 7068, SYRACUSE, NY, 13261-7068, US

(73) Assignee: Dai Nippon Printing Co., Ltd., Shinjuku-Ku (JP)

(21) Appl. No.: 10/594,933

(22) PCT Filed: Mar. 30, 2005
(86) PCT No.: PCT/JP05/06088

§ 371 Date: Oct. 29, 2007

(30) Foreign Application Priority Data
Mar. 31, 2004 (JP) 2004-106597
Mar. 28, 2005 (JP) 2005-092521

(51) Int. Cl. B32B 7/02; G02B 1/10; G02B 1/11

(52) U.S. Cl. 428/212; 428/411.1; 359/601

(57) ABSTRACT

Disclosed is a thin-film laminate which could have effectively prevented interface reflection and the occurrence of interference fringes by rendering the interface substantially absent. The thin-film laminate comprises: a light-transparent base material; and an antistatic layer and a hardcoat layer provided in that order on the light-transparent base material, wherein the interface of the light-transparent base material and the antistatic layer is substantially absent and/or the interface of the antistatic layer and the hardcoat layer is substantially absent.

### TECHNICAL FIELD

The present invention relates to a thin-film laminate that has prevented the occurrence of interface reflection and interference fringes.

### BACKGROUND ART

Image display surfaces in image display devices such as liquid crystal displays (LCDs) or cathode ray tube display devices (CRTs) are required to reduce the reflection of light applied from an external light source such as a fluorescent lamp and thus to enhance the visibility of the image. To meet this demand, a thin-film laminate (for example, an antireflective laminate) having a reduced reflectance achieved by covering the surface of a transparent object with a transparent film having a low refractive index has been provided to reduce the reflection of light from an image display surface in the image display device and thus to improve the visibility.

In the production of a thin-film laminate which can realize antireflection, a wet coating method in which a coating liquid prepared for the formation of each layer is coated, has been mainly adopted from the viewpoints of easiness of production and low cost. An antireflective laminate comprising a light-transparent base material and an antistatic layer, a hardcoat layer, and a refractive index layer provided in that order on a surface of the light-transparent base material may be mentioned as an example of the thin-film laminate formed by this wet coating method.

A laminate comprising a larger-refractive index layer (for example, a hardcoat layer having a refractive index around 1.5) and a lower-refractive index layer may be mentioned as a laminate for further light reflection reduction. In the wet coating method, both the above layers can be formed by selecting and coating materials having a large refractive index difference therebetween.

In an antireflective laminate comprising layers with a large refractive index difference stacked on top of each other, however, interface reflection and interference fringes often occur at the interface of the mutually superimposed layers. In particular, when black is reproduced on an image display surface in a screen display device, the occurrence of interference fringes is significant, resulting in lowered visibility of the image. Furthermore, it has been regarded that, when a layer having a very low refractive index (for example, less than 1.2) is stacked, the production of an antireflective laminate simultaneously having the adhesion to other layer(s) and the mechanical strength of the laminate per se is difficult.

On the other hand, Japanese Patent Laid-Open No. 75605/2003 proposes an antireflection hardcoat sheet comprising a transparent base material film and, provided on the transparent base material film in the following order, an intermediate-refractive index layer having a refractive index of 1.5 to 1.7, a higher-refractive index layer having a refractive index of 1.6 to 1.8, and further a lower-refractive index layer formed of a material having a lower refractive index than the higher-refractive index layer stacked. The claimed advantage of this antireflection hardcoat sheet is to eliminate the interface reflection, interference fringes and the like. This prior art technique has been accomplished by aiming at the material per se which constitutes each layer.

So far as the present inventors know, up to now, there is no proposal aiming at the interface between a light-transparent base material and an antistatic layer and the interface between an antistatic layer and a hardcoat layer in a thin-film laminate, and suggesting that the occurrence of interface reflection and interference fringes can be effectively prevented by improving the interface state.

### RELATED APPLICATION

This application is based upon and claims the benefit of priority from the prior Japanese Patent Application No. 106597/2004 and Japanese Patent Application No. 92521/2005, the entire contents of which are incorporated herein by reference.

### DISCLOSURE OF THE INVENTION

The present inventors have found that, at the time of the present invention, the occurrence of interface reflection and interference fringes can be effectively prevented by rendering the interface between the light-transparent base material and the antistatic layer and the interface between the antistatic layer and the hardcoat layer substantially absent. Accordingly, the present invention provides a thin-film laminate that aims at the interface between a light-transparent base material and an antistatic layer and the interface between the antistatic layer and the hardcoat layer and possesses mechanical strength, an excellent antireflection function and improved visibility which have been realized by rendering the interfaces substantially absent.

Thus, according to the present invention, there is provided a thin-film laminate comprising: a light-transparent base material; and an antistatic layer and a hardcoat layer provided in that order on the light-transparent base material, wherein

the interface between the light-transparent base material and the antistatic layer is absent and/or

the interface between the hardcoat layer and the antistatic layer is absent.

The thin-film laminate according to the present invention can effectively prevent the occurrence of interference reflection and interference fringes at the interface between the light-transparent base material and the antistatic layer and the interface between the antistatic layer and the hardcoat layer. Further, an improvement in mechanical strength of the thin-film laminate per se through an improvement in adhesion of each layer can be realized by selecting ingredients for preparing a composition for an antistatic layer and a composition for a hardcoat layer that can form the above laminate structure.

### BRIEF DESCRIPTION OF THE DRAWINGS

FIG. 1 is a schematic diagram of a laser photomicrograph of the cross section of an optical laminate according to the present invention.

FIG. 2 is a schematic diagram of a laser photomicrograph of the cross section of an optical laminate prepared in Comparative Example.

### BEST MODE FOR CARRYING OUT THE INVENTION

Thin-Film Laminate

In the thin-film laminate according to the present invention, the interface between the light-transparent base material and the antistatic layer and/or the interface between the hardcoat layer and the antistatic layer have been rendered (substantially) absent. The wording “the interface is (substantially) absent” as used herein embraces not only the case where, although two faces are put on top of each other, the interface is actually absent between the two faces, but also the case where, in view of the refractive index, it is judged that an interface is absent between the two layers.

In the present invention, an embodiment in which the refractive index of the interface between the light-transparent base material and the antistatic layer is changed gradationally from the refractive index of the light transparent base material to the refractive index of the antistatic layer, may be mentioned as the embodiment where “the interface is (substantially) absent.” Another preferred embodiment where “the interface is (substantially) absent” is one where the refractive index of the interface between the antistatic layer and the hardcoat layer is changed gradationally from the refractive index of the antistatic layer to the refractive index of the hardcoat layer.

Here the wording “the interface is (substantially) absent” as used herein embraces not only the case where, although two layer surfaces are put on top of each other, the interface is actually absent between the two layer surfaces, but also the case where, in view of the refractive index, it is judged that an interface is absent between the two layer surfaces. The specific standard of “the interface is (substantially) absent” may be, for example, that in the observation of the cross section of an optical laminate under a laser microscope, an interface is present in the cross section of the laminate in which interference fringes are visually observed, while an interface is absent in the cross section of the laminate in which interference fringes are not visually observed. The laser microscope can nondestructively observe the cross section of a laminate comprising layers different from each other in refractive index, and, thus, in a laminate comprising materials not having any significant refractive index difference, the results of measurement are such that any interface is not present. Accordingly, also based on the refractive index, it can be judged that any interface is not present between the light-transparent base material and the hardcoat layer. Further, for the antistatic layer, the results of measurement are that there is no clear linear interface between the hardcoat layer and the light-transparent base material.

Substantial Disappearance of Interface

In a preferred embodiment of the present invention, rendering the interface between the light-transparent base material and the antistatic layer substantially absent can be realized by forming the antistatic layer using a composition for an antistatic layer penetrable into the light-transparent base material. On the other hand, rendering the interface between the antistatic layer and the hardcoat layer substantially absent can be realized by forming the hardcoat layer using a composition for a hardcoat layer penetrable into the antistatic layer.

In the present invention, upon coating of a composition for an antistatic layer penetrable into the light-transparent base material onto the light-transparent base material, this composition is penetrated into the light transparent base material (that is, the light transparent base material is wetted with the composition). Thereafter, an antistatic layer is formed on the light-transparent base material by curing the composition. As a result, an interface is substantially absent on a face where both the light-transparent base material and the antistatic layer are superimposed on top of each other. The mechanism cannot be easily understood but is considered to be that, between the light-transparent base material and the antistatic layer, a change in component occurs gradationally from the component of the light-transparent base material toward the component of the antistatic layer. This is true of the case where the hardcoat layer is formed on the surface of the antistatic layer.

The optical laminate according to the present invention comprises a light-transparent base material and an antistatic layer and a hardcoat layer provided in that order on the light-transparent base material. Alternatively, the hardcoat layer and the antistatic layer are may be provided in that order on the light-transparent base material.

1. Light-Transparent Base Material

The light-transparent base material may be transparent, semi-transparent, colorless or chromatic so far as it is transparent to light. Preferably, however, the light-transparent base material is colorless and transparent.

Specific examples of light-transparent base materials include glass plates, or thin films formed, for example, by cellulose triacetate (TAC), polyethylene terephthalate (PET), diacetyl cellulose, cellulose acetate butylate, polyethersulfone, or acrylic resin; polyurethane resin; polyester; polycarbonate; polysulfone; polyether; trimethylpentene; polyether ketone; or (meth)acrylonitrile. In a preferred embodiment of the present invention, triacetate cellulose (TAC) is preferred. The thickness of the light-transparent base material is about 30 μm to 200 μm, preferably 50 μm to 200 μm.

2. Antistatic Layer

The antistatic layer according to the present invention is formed of a penetrative composition for an antistatic layer, comprising an antistatic agent, a resin, and a solvent. The composition for an antistatic layer is prepared so as to be penetrable into the light-transparent base material. The thickness of the antistatic layer is preferably about 30 nm to 5 μm.

Antistatic Agent (Electrically Conductive Agent)

Specific examples of antistatic agents usable for antistatic layer formation include quaternary ammonium salts, pyridinium salts, various cationic compounds containing cationic groups such as primary to tertiary amino groups, anionic compounds containing anionic groups such as sulfonic acid bases, sulfuric ester bases, phosphoric ester bases, and phosphonic acid bases, amphoteric compounds such as amino acid and aminosulfuric acid ester compounds, nonionic compounds such as amino alcohol, glycerin, and polyethylene glycol compounds, organometal compounds such as alkoxides of tin and titanium, and metal chelate compounds such as their acetyl acetonate salts. Further, compounds prepared by increasing the molecular weight of the above exemplified compounds may also be mentioned. Furthermore, monomers or oligomers, which contain a tertiary amino group, a quaternary ammonium group, or a metal chelate part and are polymerizable by an ionizing radiation, or polymerizable compounds, for example, organometal compounds such as coupling agents containing a functional group(s) polymerizable by an ionizing radiation, may also be used as the antistatic agent.

Electrically conductive ultrafine particles may also be mentioned. Specific examples of electrically conductive fine particles include fine particles of metal oxides. Such metal oxides include ZnO (refractive index 1.90; numerical value within the parentheses referred to hereinbelow being a refractive index value), CeO₂ (1.95), Sb₂O₂ (1.71), SnO₂ (1.997), indium tin oxide often abbreviated to ITO (1.95), In₂O₃ (2.00), Al₂O₃ (1.63), antimony doped tin oxide (abbreviation; ATO, 2.0), and aluminum doped zinc oxide (abbreviation; AZO, 2.0).Fine particles refer to particles having a size of not more than 1 micron, that is, the so-called submicron size, preferably having an average particle diameter of 0.1 nm to 0.3 μm.

Resin

Specific examples of resins usable herein include thermoplastic resins, heat curing resins, or ionizing radiation curing resins or ionizing radiation curing compounds (including organic reactive silicon compounds). Thermoplastic resins may be used as the resin. More preferably, heat curing resins are used. Still more preferred are ionizing radiation curing resins or ionizing radiation curing compound-containing ionizing radiation curing compositions.

The ionizing radiation curing composition is a composition prepared by properly mixing a prepolymer, oligomer and/or monomer containing a polymerizable unsaturated bond or epoxy group in its molecule together. The ionizing radiation refers to a radiation having an energy quantum which can polymerize or crosslink the molecule among electromagnetic waves or charged particle beams and is generally ultraviolet light or electron beams.

Examples of prepolymers and oligomers in the ionizing radiation curing composition include unsaturated polyesters such as condensates of unsaturated dicarboxylic acids and polyhydric alcohols, methacrylates such as polyester methacrylate, polyether methacrylate, polyol methacrylate, and melamine methacrylate, acrylates such as polyester acrylate, epoxy acrylate, urethane acrylate, polyether acrylate, polyol acrylate, and melamine acrylate, and cation polymerizable epoxy compounds.

Examples of monomers in the ionizing radiation curing composition include styrene monomers such as styrene and α-methyl styrene, acrylic esters such as methyl acrylate, 2-ethylhexyl acrylate, methoxyethyl acrylate, butoxyethyl acrylate, butyl acrylate, methoxybutyl acrylate, and phenylacrylate, methacrylic esters such as methyl methacrylate, ethyl methacrylate, propyl methacrylate, methoxyethyl methacrylate, ethoxymethyl methacrylate, phenyl methacrylate, and lauryl methacrylate, unsaturated substituted amino alcohol esters such as 2-(N,N-diethylamino)ethyl acrylate, 2-(N,N-dimethylamino)ethylacrylate, 2-(N,N-dibenzylamino)methylacrylate, and 2-(N,N-diethylamino)propyl acrylate, unsaturated carboxylic acid amides such as acrylamide and methacrylamide, compounds such as ethylene glycol diacrylate, propylene glycol diacrylate, neopentyl glycol diacrylate, 1,6-hexanediol diacrylate, and triethylene glycol diacrylate, polyfunctional compounds such as dipropylene glycol diacrylate, ethylene glycol diacrylate, propylene glycol dimethacrylate, and diethylene glycol dimethacrylate, and/or polythiol compounds containing two or more thiol groups in the molecule thereof, for example, trimethylolpropane trithioglycolate, trimethylolpropane trithiopropylate, and pentaerythritol tetrathioglycolate. In general, according to need, one of or a mixture of two or more of the above compounds is used as the monomer in the ionizing radiation curing composition.

When flexibility is required of a film formed by coating the ionizing radiation curing composition and curing the coating, this requirement can be met by reducing the amount of the monomer or using an acrylate monomer having one or two functional groups. When abrasion resistance, heat resistance, and solvent resistance are required of a film formed by coating the ionizing radiation curing composition and curing the coating, this requirement can be met by tailoring the design of the ionizing radiation curing composition, for example, by using an acrylate monomer having three or more functional groups. Monofunctional acrylate monomers include 2-hydroxy acrylate, 2-hexyl acrylate, and phenoxyethyl acrylate. Difunctional acrylate monomers include ethylene glycol diacrylate and 1,6-hexanediol diacrylate. Tri- or higher functional acrylate monomers include trimethylolpropane triacrylate, pentaerythritol triacrylate, pentaerythritol tetraacrylate, and dipentaerythritol hexaacrylate.

In order to regulate properties such as flexibility or surface hardness of a film formed by coating the ionizing radiation curing composition and curing the coating, a resin not curable by ionizing radiation irradiation may also be added to the ionizing radiation curing composition. Specific examples of resins usable herein include thermoplastic resins such as polyurethane resins, cellulosic resins, polyvinyl butyral resins, polyester resins, acrylic resins, polyvinylchloride resins, and polyvinyl acetate. Among them, polyurethane resins, cellulosic resins, polyvinyl butyral resins and the like are preferably added from the viewpoint of improving the flexibility.

When curing after coating of the ionizing radiation curing composition is carried out by ultraviolet light irradiation, photopolymerization initiators or photopolymerization accelerators are added. In the case of radically polymerizable unsaturated group-containing resins, photopolymerization initiators usable herein include acetophenones, benzophenones, thioxanthones, benzoins, and benzoin methyl ethers. They may be used either solely or as a mixture of two or more. In the case of cationically polymerizable functional group-containing resins, photopolymerization initiators usable herein include aromatic diazonium salts, aromatic sulfonium salts, aromatic iodonium salts, metallocene compounds, benzoin sulfonates and the like. They may be used either solely or as a mixture of two or more. The amount of the photopolymerization initiator added is 0.1 to 10 parts by weight based on 100 parts by weight of the ionizing radiation curing composition.

The ionizing radiation curing composition may be used in combination with the following organic reactive silicon compound.

The organic silicon compound is represented by general formula RₘSi(OR′)ₙ wherein R and R′ represent an alkyl group having 1 to 10 carbon atoms; and m and n each are an integer satisfying a relationship represented by m+n=4.

Specific examples thereof include tetramethoxysilane, tetraethoxysilane, tetra-iso-propoxysilane, tetra-n-propoxysilane, tetra-n-butoxysilane, tetra-sec-butoxysilane, tetra-tert-butoxysilane, tetrapentaethoxysilane, tetrapenta-iso-propoxysilane, tetrapenta-n-propoxysilane, tetrapenta-n-butoxysilane, tetrapenta-sec-butoxysilane, tetrapenta-tert-butoxysilane, methyltriethoxysilane, methyltripropoxysilane, methyltributoxysilane, dimethyldimethoxysilane, dimethyldiethoxysilane, dimethylethoxysilane, dimethylmethoxysilane, dimethylpropoxysilane, dimethylbutoxysilane, methyldimethoxysilane, methyldiethoxysilane, and hexyltrimethoxysilane.

Organic silicon compounds usable in combination with the ionizing radiation curing composition are silane coupling agents. Specific examples thereof include γ-(2-aminoethyl) aminopropyltrimethoxysilane, γ-(2-aminoethyl) aminopropylmethyldimethoxysilane, β-(3,4-epoxycyclohexyl) ethyltrimethoxysilane, γ-aminopropyltriethoxysilane, γ-methacryloxypropylmethoxysilane, N-β-(N-vinylbenzylaminoethyl)-γ-aminopropylmethoxysilane hydrochloride, γ-glycidoxypropyltrimethoxysilane, aminosilane, methylmethoxysilane, vinyltriacetoxysilane, γ-mercaptopropyltrimethoxysilane, γ-chloropropyltrimethoxysilane, hexamethyldisilazane, vinyl-tris(β-methoxyethoxy) silane, octadecyldimethyl[3-(trimethoxysilyl) propyl]ammonium chloride, methyltrichlorosilane, and dimethyldichlorosilane.

Solvent

Specific examples of solvents include alcohols such as isopropyl alcohol, methanol, and ethanol; glycols such as propylene glycol; glycol ethers such as propylene glycol monopropyl ether; ketones such as methyl ethyl ketone (hereinafter often referred to as “MEK”), methyl isobutyl ketone (hereinafter often referred to as “MIBK”), and cyclohexanone; esters such as ethyl acetate, and butyl acetate; halogenated hydrocarbons; aromatic hydrocarbons such as toluene and xylene; and mixtures thereof. Preferred are ketones.

In the present invention, solvents, which can penetrate (wet) a light transparent base material, are used. Accordingly, in the present invention, the term “penetrating” referred to in connection with the penetrating solvent include all of concepts of penetrating properties, swelling properties, wetting properties and the like with respect to light transparent base materials. Specific examples of penetrating solvents include: alcohols such as isopropyl alcohol, methanol, and ethanol; ketones such as methyl ethyl ketone, methyl isobutyl ketone, and cyclohexanone; esters such as methyl acetate, ethyl acetate, and butyl acetate; halogenated hydrocarbons such as chloroform, methylene chloride, and tetrachloroethane; or mixtures thereof. Preferred are esters.

Specific examples of solvents include acetone, methyl acetate, ethyl acetate, butyl acetate, chloroform, methylene chloride, trichloroethane, tetrahydrofuran, methyl ethyl ketone, methylisobutyl ketone, cyclohexanone, nitromethane, 1,4-dioxane, dioxolane, N-methylpyrrolidone, N,N-dimethylformamide, methanol, ethanol, isopropyl alcohol, butanol, isobutyl alcohol, diisopropyl ether, methyl cellosolve, ethyl cellosolve, and butyl cellosolve. Preferred are methyl acetate, ethyl acetate, butyl acetate, methyl ethyl ketone and the like.

3. Hardcoat Layer

The composition for a hardcoat layer that can penetrate the antistatic layer, is preferably prepared as follows. The term “hardcoat layer” as used herein refers to a coat layer having a hardness of “H” or more in a pencil hardness test specified in JIS 5600-5-4 (1999). The thickness of the hardcoat layer (on a cured state basis) is preferably in the range of 0.1 to 100 μm, more preferably in the range of 0.8 to 20 μm.

Resin

The hardcoat layer is preferably formed by using an ionizing radiation curing resin composition, more preferably a composition containing components having an (meth)acrylate-type functional group, for example, relatively low-molecular weight polyester resins, polyether resins, acrylic resins, epoxy resins, urethane resins, alkyd resins, spiroacetal resins, polybutadiene resins, polythiol polyether resins, polyhydric alcohols, ethylene glycol di(meth)acrylate, and pentaerythritol di(meth)acrylate monostearate or other di(meth)acrylates; trimethylolpropane tri(meth)acrylate, pentaerythritol tri(meth)acrylate, or other tri(meth)acrylates, pentaerythritol tetra(meth)acrylate derivatives, dipentaerythritol penta(meth)acrylate, or other polyfunctional compound monomers, or epoxy acrylate or urethane acrylate or other oligomers. In the present invention, pentaerythritol tri(meth)acrylate and isocyanuric acid ethoxy modified diacrylate are preferred.

Solvent

The solvent may be the same as described above in connection with the composition for an antistatic layer.

4. Lower-Refractive Index Layer

The thin film laminate according to the present invention preferably further comprises a lower-refractive index layer.

The lower-refractive index layer may be formed of a thin film comprising a silica- or magnesium fluoride-containing resin, a fluororesin as a lower-refractive index resin, or a silica- or magnesium fluoride-containing fluororesin and having a refractive index of not more than 1.46 and a thickness of about 30 nm to 1 μm, or a thin film formed by chemical deposition or physical deposition of silica or magnesium fluoride. Resins other than the fluororesin are the same as used for constituting the antistatic layer.

More preferably, the lower-refractive index layer is formed of a silicone-containing vinylidene fluoride copolymer. Specifically, this silicone-containing vinylidene fluoride copolymer comprises a resin composition comprising 100 parts of a fluorocopolymer prepared by copolymerization using, as a starting material, a monomer composition containing 30 to 90% (all the percentages being by mass; the same shall apply hereinafter) of vinylidene fluoride and 5 to 50% of hexafluoropropylene, and having a fluorine content of 60 to 70% and 80 to 150 parts of an ethylenically unsaturated group-containing polymerizable compound. This resin composition is used to form a lower-refractive index layer having a refractive index of less than 1.60 (preferably not more than 1.46) which is a thin film having a thickness of not more than 200 nm and to which scratch resistance has been imparted.

For the silicone-containing vinylidene fluoride copolymer constituting the lower-refractive index layer, the content of individual components in the monomer composition is 30 to 90%, preferably 40 to 80%, particularly preferably 40 to 70%, for vinylidene fluoride, and 5 to 50%, preferably 10 to 50%, particularly preferably 15 to 45%, for hexafluoropropylene. This monomer composition may further comprise 0 to 40%, preferably 0 to 35%, particularly preferably 10 to 30%, of tetrafluoroethylene.

The above monomer composition may comprise other comonomer component in such an amount that is not detrimental to the purpose of use and effect of the silicone-containing vinylidene fluoride copolymer, for example, in an amount of not more than 20%, preferably not more than 10%. Specific examples of other comonomer components include fluorine atom-containing polymerizable monomers such as fluoroethylene, trifluoroethylene, chlorotrifluoroethylene, 1,2-dichloro-1,2-difluoroethylene, 2-bromo-3,3,3-trifluoroethylene, 3-bromo-3,3-difluoropropylene, 3,3,3-trifluoropropylene, 1,1,2-trichloro-3,3,3-trifluoropropylene, and α-trifluoromethacrylic acid.

The fluorocopolymer produced from this monomer composition should have a fluorine content of 60 to 70%, preferably 62 to 70%, particularly preferably 64 to 68%. When the fluorine content is in the above-defined specific range, the fluoropolymer has good solubility in solvents. The incorporation of the above fluoropolymer as a component can result in the formation of a thin film which has excellent adhesion to various base materials, has a high level of transparency and a low level of refractive index and, at the same time, has satisfactorily high mechanical strength. Therefore, the surface with the thin film formed thereon has a satisfactorily high level of mechanical properties such as scratch resistance which is very advantageous.

Preferably, the molecular weight of the fluorocopolymer is 5,000 to 200,000, particularly preferably 10,000 to 100,000, in terms of number average molecular weight as determined using polystyrene as a standard. When the fluorocopolymer having this molecular weight is used, the fluororesin composition has suitable viscosity and thus reliably has suitable coatability. The refractive index of the fluorocopolymer per se is preferably not more than 1.45, particularly preferably not more than 1.42, still more preferably not more than 1.40. When a fluorocopolymer having a refractive index exceeding 1.45 is used, in some cases, the thin film formed from the resultant fluorocoating material has a low level of antireflection effect.

The lower-refractive index layer may also be formed of a thin film of SiO₂. This lower-refractive index layer may be formed, for example, by vapor deposition, sputtering, or plasma CVD, or by a method in which an SiO₂ gel film is formed from a sol liquid containing an SiO₂ sol. In addition to SiO₂, a thin film of MgF₂ or other material may constitute the lower-refractive index layer. However, the use of a thin film of SiO₂ is preferred from the viewpoint of high adhesion to the lower layer. Among the above methods, when plasma CVD is adopted, a method is preferably adopted in which an organosiloxane is used as a starting gas and the CVD is carried out in such a state that other inorganic vapor deposition sources are not present. Further, preferably, in the CVD, the substrate is kept at the lowest possible temperature.

Production Process of Thin-Film Laminate

Preparation of Composition

Each composition for the antistatic layer, the hardcoat layer, and the lower-refractive index layer may be prepared according to a conventional preparation method by mixing the above-described components together and subjecting the mixture to dispersion treatment. The mixing and dispersion can be properly carried out, for example, by a paint shaker or a beads mill.

Coating

Specific examples of methods usable for coating each composition onto the surface of the light transparent base material and the surface of the antistatic layer include various methods, for example, spin coating, dip coating, spraying, slide coating, bar coating, roll coating, meniscus coating, flexographic printing, screen printing, or bead coating.

### PREFERRED EMBODIMENTS

Preferred embodiments of the thin-film laminate according to the present invention will be described.

Formation of Antistatic Layer

The following penetrative composition for an antistatic layer was coated on triacetate cellulose (TAC) as a light-transparent base material to form an antistatic layer.

Preparation of Composition for Antistatic Layer

Antistatic Agent

The antistatic agent may be any antistatic agent. Preferred are metal fine particles, and more preferred are antimony-doped tin oxide (ATO).

Resin

The resin may be an ionizing radiation curing composition, preferably an acrylate monomer having one or at least two functional groups. Examples of acrylate monomers having one functional group include 2-hydroxyacrylate, 2-hexylacrylate, and phenoxyethyl acrylate. Examples of acrylate monomers having two functional groups include ethylene glycol diacrylate, and 1,6-hexanediol diacrylate. Examples of acrylate monomers having three or more functional groups include trimethylolpropane triacrylate, pentaerythritol triacrylate, pentaerythritol tetraacrylate, and dipentaerythritol hexaacrylate. 1,6-Hexanediol diacrylate is more preferred.

Solvent

Specific examples of preferred solvents include ketones such as methyl ethyl ketone, methyl isobutyl ketone, and cyclohexanone (preferred solvent); esters such as ethyl acetate and butyl acetate (preferred solvent); halogenated hydrocarbons; aromatic hydrocarbons such as toluene and xylene; or mixtures of these solvents. The addition ratio of the resin to the solvent on a weight basis is 1:1 to 1:3, preferably 3:4.

In a preferred embodiment of the present invention, the antistatic layer is preferably formed from a composition prepared by mixing an antistatic agent (preferably metallic fine particles), an ionizing radiation curing composition as a resin, ketones and/or esters as a solvent together.

The composition for an antistatic layer according to the present invention is preferably a mixture composition comprising antimony-doped tin oxide (ATO) as an antistatic agent, 1,6-hexanediol diacrylate, dipentaerythritol hexaacrylate, pentaerythritol triacrylate, or dipentaerythritol monohydroxypentaacrylate (DPPA) as a resin, cyclohexanone or butyl acetate or a mixture of cyclohexanone with butyl acetate as a solvent.

The composition for an antistatic layer is more preferably a mixture composition comprising antimony-doped tin oxide (ATO) as an antistatic agent, 1,6-hexanediol diacrylate as a resin, and cyclohexanone and butyl acetate as a solvent. In this case, the mixing ratio of cyclohexanone to butyl acetate on a weight basis is 20:80 to 80:20, preferably 30:70.

Formation of Hardcoat Layer

The following penetrative composition for a hardcoat layer is coated onto the antistatic layer to form an optical laminate.

Preparation of Composition for Hardcoat Layer

Resin

Specific examples of preferred resins include ionizing radiation curing compositions, preferably pentaerythritol triacrylate (PETA).

Solvent

Specific examples of preferred solvents include MEK, MIBK, ketones such as cyclohexanone (preferred); esters such as ethyl acetate, and butyl acetate (preferred); halogenated hydrocarbons; aromatic hydrocarbons such as toluene and xylene; or their mixtures, MEK, and MIBK.

The addition ratio of the resin to the solvent on a weight basis is 20:80 to 80:20, preferably 55:70. The composition for a hardcoat layer according to the present invention is preferably a mixture composition comprising pentaerythritol triacrylate or isocyanuric acid ethoxy-modified diacrylate as a resin and cyclohexanone, MIBK, MEK, or a mixture thereof as a solvent. The solvent is preferably a mixture composition composed of cyclohexanone, MIBK, and MEK. In this case, the mixing ratio of cyclohexanone to MIBK to MEK on a weight basis is 5:2:3.

Use of Thin-Film Laminate

The thin-film laminate according to the present invention can be used in the following applications.

Antireflection Laminate

The thin-film laminate according to the present invention is used as an antireflection laminate.

Polarizing Plate

According to another aspect of the present invention, there is provided a polarizing plate comprising a polarizing element and the thin-film laminate according to the present invention. Specifically, there is provided a polarizing plate comprising a polarizing element and the thin-film laminate according to the present invention provided on a surface of the polarizing element, the polarizing element being located on the thin-film laminate in its side remote from the anti-dazzling layer in the thin-film laminate.

For example, a polyvinyl alcohol film, a polyvinylformal film, a polyvinylacetal film, or an ethylene-vinyl acetate copolymer saponified film, which has been dyed with iodine or a dye and stretched, may be used as the polarizing element. In the lamination treatment, preferably, the light-transparent base material (preferably triacetylcellulose film) is saponified from the viewpoint of adhesion improvement or antistatic properties.

Image Display Device

According to a further aspect of the present invention, there is provided an image display device. The image display device comprises a transmissive display and a light source device for applying light to the transmissive display from its backside, wherein the thin-film laminate according to the present invention or the polarizing plate according to the present invention is provided on a surface of the transmissive display. The image display device according to the present invention fundamentally comprises a light source device (backlight), a display element, and the thin-film laminate according to the present invention. The image display device can be utilized in transmission display devices, particularly in displays such as televisions, computers, and word processors. Among others, the image display device can be used on the surface of displays for high-definition images, for example, CRTs and liquid crystal panels.

When the image display device according to the present invention is a liquid crystal display device, light from the light source in the light source device is applied from the lower side of the thin-film laminate according to the present invention. In the case of an STN-type liquid crystal display device, a retardation plate may be inserted into between the liquid crystal display element and the polarizing plate. If necessary, an adhesive layer may be provided between the layers in the liquid crystal display device.

### EXAMPLE

The contents of the present invention will be described in more detail with reference to the following Examples that should not be construed as limiting the present invention.

Preparation of Compositions for Each Layer

The compositions for individual layers were prepared by mixing according to the following formulations.

Composition for Antistatic Layer

Basic composition 1

| | | |
|---|---|---|
| Antistatic agent (ATO) | 30 | parts by mass |
| Pentaerythritol triacrylate | 10 | parts by mass |
| (manufactured by Nippon Kayaku Co. | | |
| Ltd., tradename; PET30) | | |
| Cyclohexanone | 30 | parts by mass |
| MIBK | 30 | parts by weight |
| Dispersant | 2.5 | parts by mass |

Basic composition 2

| | | |
|---|---|---|
| Antistatic agent (ATO) | 30 | parts by mass |
| Pentaerythritol triacrylate | 10 | parts by mass |
| (manufactured by Nippon Kayaku Co. | | |
| Ltd., tradename; PET30) | | |
| Toluene | 60 | parts by mass |
| Dispersant | 2.5 | parts by mass |

Composition 1 for antistatic layer

| | | |
|---|---|---|
| Basic composition 1 | 100 | parts by mass |
| Initiator (manufactured by Ciba Specialty | 5 | parts by mass |
| Chemicals, K.K., tradename; Irgacure 907) | | |
| (based on resin component) Cyclohexanone | 219 | parts by mass |
| MIBK | 219 | parts by weight |

Composition 2 for antistatic layer

| | | |
|---|---|---|
| Basic composition 2 | 100 | parts by mass |
| Pentaerythritol triacrylate | 3.5 | parts by mass |
| Initiator (manufactured by Ciba Specialty | 5 | parts by mass |
| Chemicals, K.K., tradename; Irgacure 907) | | |
| (based on resin component) Toluene | 460 | parts by mass |

Composition for hardcoat layer

| | | |
|---|---|---|
| Pentaerythritol triacrylate | 100 | parts by weight |
| (manufactured by Nippon Kayaku Co., | | |
| Ltd., tradename; PET30) | | |
| Methyl ethyl ketone | 43 | parts by weight |
| Leveling agent (manufactured by | 2 | parts by weight |
| Dainippon Ink and Chemicals, Inc., | | |
| tradename; MCF-350-5) | | |
| Polymerization initiator | 6 | parts by weight |
| (manufactured by Ciba Specialty | | |
| Chemicals, K.K., tradename; | | |
| Irgacure 184) | | |

Preparation of Thin-Film Laminate

### Example 1

A light-transparent base material (triacetylcellulose resin film with thickness of 80 μm (TF80UL, manufactured by Fuji Photo Film Co., Ltd.) was provided. Composition 1 for an antistatic layer was coated by a wound coating rod onto one side of the film. The coated film was held in a hot oven kept at a temperature of 70° C. for 30 sec to evaporate the solvent in the coating film. Thereafter, the coating film was cured by applying ultraviolet light to the coated film so that the integrated quantity of light was 98 mJ. Thus, a transparent antistatic layer was formed at a coverage of 0.7 g/cm² (on a dry basis) to prepare an antistatic laminate. Thereafter, the composition for a hardcoat layer was coated, and the assembly was held in a hot oven kept at a temperature of 70° C. for 30 sec to evaporate the solvent in the coating film. Thereafter, the coating film was cured by applying ultraviolet light to the coating film so that the integrated quantity of light was 46 mJ. Thus, a hardcoat layer was formed at a coverage of 15 g/cm² (on a dry basis) to prepare a thin-film laminate.

### Comparative Example 1

A thin-film laminate was prepared in the same manner as in Example 1, except that composition 2 for an antistatic layer was used.

Evaluation Test

The thin-film laminates prepared in Example 1 and Comparative Example 1 were subjected to the following evaluation tests. The results are shown in Table 1.

Evaluation 1: Interference Fringes

A black tape for the prevention of reflection of light from backside was applied to the surface of the thin-film laminate remote from the hardcoat layer, and the thin-film laminate was visually inspected from the surface of the hardcoat layer. The results were evaluated based on the following criteria.

Evaluation Criteria

⊚: Interference fringes did not occur.

x: Interference fringes occurred.

Evaluation 2: Interface

The cross section of the thin-film laminate was observed in a transmission manner under a confocal laser microscope (Leica TCS-NT; magnification “500 to 1000”, manufactured by Leica Microsystems) to determine whether or not an interface is present. The results were evaluated according to the following criteria. Specifically, in order to obtain halation-free sharp images, a wet-type objective lens was used in the confocal laser microscope, and about 2 ml of an oil having a refractive index of 1.518 was placed on the thin-film laminate for evaluation of the interface. The oil was used for allowing an air layer between the objective lens and the thin-film laminate to disappear.

Evaluation Criteria

⊚: No interface was observed (note 1).

x: An interface was observed (note 2).

Notes 1 and 2

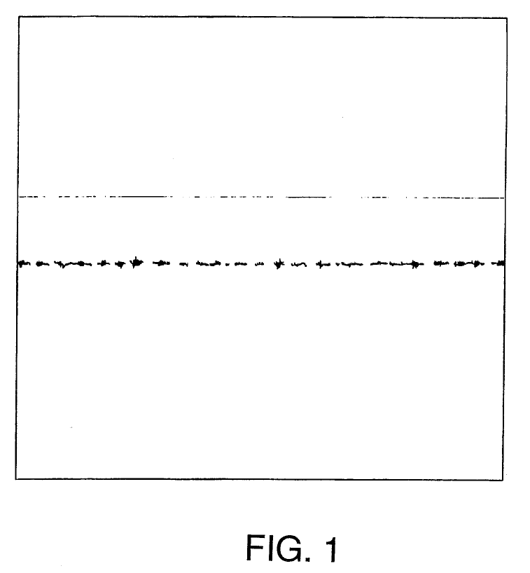

Note 1: In Example 1, as shown in FIG. 1, the interface of oil surface/hardcoat layer and the antistatic agent contained in the antistatic layer were observed, and the interface between the hardcoat layer and the antistatic layer and the light transparent base material was not observed.

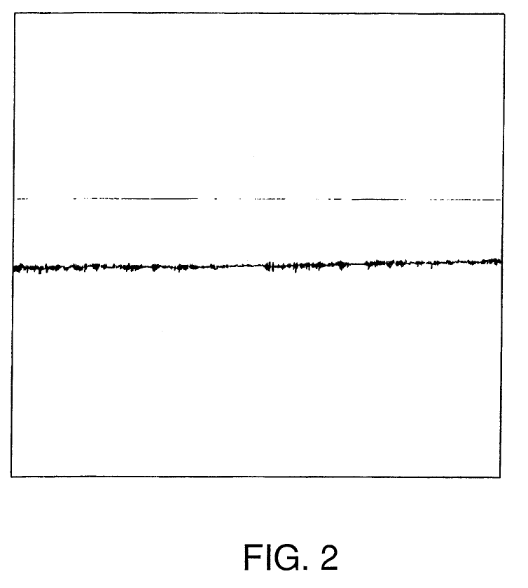

Note 2: For Comparative Example 1, as shown in FIG. 2, the interface of oil surface/hardcoat layer, the hardcoat layer, and the interface of antistatic layer/light-transparent base material were observed.

TABLE 1

| | Evaluation 1 | Evaluation 2 |
|---|---|---|
| Example 1 | ⊚ | ⊚ |
| Comparative Example 2 | X | X |

1. A thin-film laminate comprising a light-transparent base material; and an antistatic layer and a hardcoat layer provided in that order on the light-transparent base material, wherein
the interface between the light-transparent base material and the antistatic layer is absent and/or
the interface between the antistatic layer and the hardcoat layer is absent.

2. The thin-film laminate according to claim 1, wherein the interface between the light transparent base material and the antistatic layer has been rendered absent by forming the antistatic layer using a composition for an antistatic layer penetrable into the light transparent base material.

3. The thin-film laminate according to claim 1, wherein the interface between the antistatic layer and the hardcoat layer has been rendered absent by forming the hardcoat layer using a composition for a hardcoat layer penetrable into the antistatic layer.

4. The thin-film laminate according to claim 1, wherein the refractive index of the interface between the light-transparent base material and the antistatic layer is gradationally changed from the refractive index of the light-transparent base material to the refractive index of the antistatic layer.

5. The thin-film laminate according to claim 1, wherein the refractive index of the interface between the antistatic layer and the hardcoat layer is gradationally changed from the refractive index of the antistatic layer to the refractive index of the hardcoat layer.

6. The thin-film laminate according to claim 1, wherein the hardcoat layer and the antistatic layer are provided in that order on the light-transparent base material.

7. The thin-film laminate according to claim 1, wherein a lower-refractive index layer is further provided on the surface of the hardcoat layer.

8. The thin-film laminate according to claim 1, which is used as an antireflective laminate.

9. A polarizing plate comprising a polarizing element, an antireflective laminate according to claim 8 being provided on a surface of the polarizing element.

10. An image display device comprising a transmissive display and a light source device for applying light to the transmissive display from its backside,
an antireflective laminate according to claim 8 being provided on a surface of the transmissive display.

11. An image display device comprising a transmissive display and a light source device for applying light to the transmissive display from its backside,
a polarizing plate according to claim 9 being provided on a surface of the transmissive display.
